(19) United States
(12) Patent Application Publication
(10) Pub. No.: US 2026/0275065 A1
(43) Pub. Date: Sep. 17, 2026

(54) METHOD FOR PRODUCING POLYCARBONATE BEADS

(71) Applicant: Covestro Deutschland AG, Leverkusen (DE)

(72) Inventors: Anna Bronova, Bonn (DE); Tim Hungerland, Köln (DE); Marius Nolte, Köln (DE); Andreas Klein, Leverkusen (DE); Ulrich Grosser, Kürten (DE); Birgit Mannel, Mülheim an der Ruhr (DE); Daniel Raps, Köln (DE); Nick Weingart, Bayreuth (DE); Volker Altstädt, Hamburg (DE)

(21) Appl. No.: 19/473,567

(22) PCT Filed: Apr. 18, 2024
(86) PCT No.: PCT/EP2024/060485

§ 371 Date: Oct. 8, 2025

(30) Foreign Application Priority Data
Apr. 19, 2023 (EP) 23168652.8

(51) Int. Cl. C08J 9/18; C08G 64/42; C08J 9/12

(52) U.S. Cl. CPC C08J 9/18; C08G 64/42; C08J 9/122; C08J 2203/06; C08J 2369/00

(57) ABSTRACT

The invention describes a method for producing polycarbonate beads using a chain extender. The polycarbonate beads have a low bulk density and are suitable for the production of moulded parts with good surface properties and good mechanical properties.

The invention relates to a process for producing polycarbonate beads, to the polycarbonate beads, obtainable by the process, and to molded articles obtainable from the polycarbonate beads.

Particle foams, and here in particular EPS, EPP and E-TPU, are becoming increasingly important. Modern technology now makes it possible to produce particle foams of reliable quality and to use these particle foams to produce components having advantageous properties. The lower bulk density compared to the “simple” thermoplastics opens up new fields of application for the expanded materials, or conventional applications can be achieved with distinct weight savings. Expanded thermoplastics are thus an attractive material, especially for lightweight applications, provided that application-specific properties are sufficiently good. Mold developments in recent years permit production even of components having surfaces having such an appearance that even visible parts made of expanded thermoplastics are a real alternative to corresponding injection moldings, while having distinctly lower weight. Because of the lower material consumption, the expanded materials are also attractive from a sustainability point of view and can additionally contribute to energy savings owing to generally good thermal insulation properties, for instance when they are used as a thermal insulation material or as an additional effect when they are used as an insulation material for noise suppression.

Particle foams made of polycarbonate have also already been described. Particle foams made from engineering thermoplastics are of interest to the automotive industry, for example, owing to properties such as high thermal stability and good fire performance. EPC is a particle foam for-high temperature applications where conventional polymer foams such as EPP fail. DE 4100200 A1 describes a process for producing polycarbonate foam from polycarbonate, in which a transesterification catalyst is added to the aromatic polycarbonate in combination with aromatic polycarbonate acids or water, optionally together with aliphatic hydroxycarboxylic acids and/or aliphatic alcohols. This results in a controlled, partial degradation of the polycarbonate with release of CO₂, which serves to foam the remaining polycarbonate. The polycarbonate foams described in the document have densities around 0.4 to 0.8 g/cm³.

EP 3858906 A1 describes a process for producing expandable particles from aromatic polycarbonate by extruding aromatic polycarbonate, pelletizing, impregnating with carbon dioxide as blowing agent and expanding the particles, followed by shaping of the particles to obtain an expanded molding.

EP 2603549 A1 describes polyester foams and explicitly also considers them to include polycarbonate foams which, as well as a low density, have good processibility. For production of these particle foams, a starting polymer material in which crystallinity, reflected by the enthalpy of fusion, glass transition temperature and melting temperature are in a certain range is chosen. The process for producing the particle foams comprises the providing of corresponding starting polymer components in the molten state, the mixing of a blowing agent component and optionally of one or more additives into the melt, the extrusion and the pelletizing of the blowing agent-containing melt under water under elevated pressure of 1 to 20 bar. EP 2603549 A1 also describes the option in principle of stabilizing the extrusion operation by increasing the molecular weight by adding chain extenders, for example, without giving specific amounts. Nor are there any further requirements placed on the polymer used therein.

The object was thus to provide low-density polycarbonate beads that have been improved over the prior art via a continuous process, from which molded articles with better mechanical properties can be produced.

It has now been found that, surprisingly, molded articles made from polycarbonate particle foams, from what are called foamed “polycarbonate beads”, having sufficiently good mechanical properties are obtainable only when a chain extender is reacted in a particular amount with polycarbonate comprising a particular amount of OH end groups. It is only in this way that the process control with reactive particle foam extrusion that is required for good mechanical properties is enabled, such that foaming can proceed at high melt temperatures T of T₁=(T_{g}+110° C.) to T₂=(T_{g}+170° C.) (with T_{g}=the glass transition temperature of the aromatic polycarbonate-based composition) above the customary temperature range for foam production via extrusion of thermoplastics with physical blowing agent for expansion to low-density foams, and with simultaneously high pressures. The person skilled in the art will understand “particle foam extrusion” according to the prior art to mean a complete or partial extrusion process with addition of a blowing gas with subsequent pelletization and cooling to give expanded particles, in the case of amorphous thermoplastics at melt temperatures of T_{g}+10° C. to T_{g}+70° C. with T_{g}=the glass transition temperature of the polymer material.

The invention therefore provides a process, especially a continuous process, for producing polycarbonate beads, comprising the following steps, preferably in this sequence:
a) providing an aromatic polycarbonate-based composition, where the aromatic polycarbonate, based on the total weight of the aromatic polycarbonate, has a content of OH end groups of at least 350 ppm, determined by ¹H NMR spectroscopy with dichloromethane as solvent at room temperature,
b) mixing the aromatic polycarbonate-based composition with a chain extender suitable for OH groups in such a molar ratio that 0.64 to 1.10 mol of the reactive group of the chain extender is used per 1 mol of OH end groups of the polycarbonate,
c) providing the mixture in a plastified state,
d) mixing a physical blowing agent into the melt,
e) particle foam extrusion of the plastified mixture at a temperature T of the plastified mixture of T₁=(T_{g}+110° C.) to T₂=(T_{g}+170° C.), where T_{g} is the glass transition temperature of the aromatic polycarbonate-based composition,
f) pelletizing the blowing agent-containing melt.

The final pelletization results in foamed polycarbonate beads.

The content of OH end groups is determined by ¹H NMR spectroscopy with dichloromethane as solvent at room temperature by evaluating the ratio of the integrals of the signals at 6.68 ppm (two aromatic protons in ortho positions to phenolic OH groups) and at 1.68 ppm (six methyl protons of the bisphenol A unit).

Glass transition temperature is determined in accordance with DIN EN ISO 11357-1:2017.

“Providing the mixture in a plastified state” means that it is in the form of a polymer melt.

Unless explicitly stated otherwise, all amounts in ppm in the present invention should be regarded as proportions by weight.

There is a minimum value for the amount of the OH end groups and also for the concentration of chain extenders, but also a maximum concentration for foam extrusion at high melt temperatures T of T₁=(T_{g}+110° C.) to T₂=(T_{g}+170° C.), preferably T of T₁=(T_{g}+120° C.) to T₂=(T_{g}+160° C.), more preferably in the range from T₁=(T_{g}+130° C.) to T₂=(T_{g}+150° C.) for particle foam production, in order hence to obtain a polycarbonate particle foam with good mechanical properties in the bulk density range of 150 to 250 g/L, determined on the basis of DIN EN ISO 60:2000-01. What is meant here by “on the basis of” is that, rather than the standardized aluminum container with known volume, a 1 L beaker was filled and its contents were weighed to determine the density of the material.

The number of OH groups of the aromatic polycarbonate has a significant influence on whether beads with a low density and good mechanical properties of the resulting molded articles can be obtained. Too many OH groups in the polycarbonate mean excessively high reactivity of the polycarbonate, which ultimately leads to rearrangement reactions of the polycarbonate chain, a decrease in molecular weight owing to excessively fast branching with an associated excessively rapid increase in viscosity (excessively high shear input), and to yellowing. However, too few OH groups in the polycarbonate have the effect that the reaction with the chain extender is inadequate or does not even run. However, this likewise means that no good particle foam with adequate mechanical properties is obtained. Instead, the particle foam then has a large number of broken, collapsed cells.

According to the invention, the OH end group content of the aromatic polycarbonate used in the process is at least 350 ppm, preferably 350 ppm to 600 ppm, further preferably 380 ppm to 580 ppm, more preferably 400 ppm to 550 ppm, most preferably 450 to 550 ppm, based on the total weight of aromatic polycarbonate used. The reference value here is pure aromatic polycarbonate, not the aromatic polycarbonate-based composition. In order to achieve such an end group content, preferably more than 70% by weight of SPC, based on the total weight of the aromatic polycarbonate used, is used, further preferably at least 80% by weight of SPC, based on the total weight of the aromatic polycarbonate used; most preferably, exclusively SPC is used as the aromatic polycarbonate for the production of polycarbonate beads.

Also important is the concentration of the chain extender. An excessive amount of chain extender leads to non-processibility of the material owing to resultant excessively high viscosities as a result of an excessive increase in molecular weight of the polycarbonate. Too small an amount of chain extender does not result in any significant increase in molecular weight and hence results in an adequate increase in pressure (viscosity of PC without/with insufficient CE at 300° C. is too low) and ultimately poorer mechanical properties, in that the reaction of the chain extender with the polycarbonate is a function of time and temperature. The foam extrusion process in the case of bisphenol-A based homopolycarbonate is preferably effected, for example, at a housing temperature of T_{housing} of T_{1housing}=T_{g}+100° C. to T_{2housing}=T_{g}+150° C. and a melting temperature T of about T_{g}+(110 to 170° C.) after the blowing agent has been mixed in and dissolved. Particle foam production without cooling results in collapsed particles of high density. Depending on the process control, the stabilization and solidification of the foam structure via cooling means that foam expansion is stopped too quickly. The high temperatures in the process make it possible to exploit the full foaming potential of the formulation under cooling by compensating for the excessively fast cooling/solidification. However, with these temperature profiles, the pressure on the die plate without chain extender is 80-90 bar (in spite of the melt pump). The use of chain extenders increases the pressure on the die plate to 140-180 bar, preferably 150-160 bar. Particle foam production is not possible under these process conditions (temperatures) without appropriate chain extension and hence without the additional increase in viscosity.

For the resultant polycarbonate beads to have good properties, it has been found to be essential to the invention that a molar ratio (in a continuous process, there is a throughput-based metered addition) of 1 mol of OH end groups of the polycarbonate to 0.64-1.10 mol, preferably 0.71 to 1.0 mol, further preferably to 0.96 mol, even further preferably 0.8 to 0.9 mol, in particular 0.82 to 0.90 mol, of the reactive group of the chain extender is used.

Preferably, if the content in the aromatic polycarbonate of OH end groups is 400 to 550 ppm, determined by ¹H NMR spectroscopy with dichloromethane as solvent at room temperature, 0.71 to 0.96 mol of the reactive group of the chain extender is used per 1 mol of OH end groups of the polycarbonate.

The use of a chain extender results in an increase in molar mass of the polycarbonate to a range of 40 000 to 230 000 g/mol, preferably to 100 000 g/mol, which is associated with an additional increase in pressure on the die plate of about 60 to 100 bar at the temperatures at which polycarbonate is in the plastified state.

In an embodiment that is particularly preferred in accordance with the invention, the process is conducted continuously and comprises the following steps, preferably in this sequence:
a) providing an aromatic polycarbonate-based composition, where the aromatic polycarbonate, based on the total weight of the aromatic polycarbonate, has a content of OH end groups of at least 350 ppm, preferably of 400 to 550 ppm, determined by ¹H NMR spectroscopy with dichloromethane as solvent at room temperature,
b) mixing the aromatic polycarbonate-based composition with a chain extender suitable for OH groups in such an amount that 0.64 to 1.10 mol, preferably 0.71 to 1.0 mol, further preferably to 0.96 mol, even further preferably 0.8 to 0.9 mol, in particular 0.82 to 0.90 mol, of the reactive group of the chain extender is used per 1 mol of OH end groups of the polycarbonate (based on throughput) is used, where the chain extender used is an epoxy-functionalized chain extender, preferably a styrene-acrylic-based polymer comprising epoxy-reactive groups, in particular one having an epoxy equivalent weight (EEW) of 285 to 485 g/mol, determined in accordance with DIN EN 1877-1:2000,
c) providing the mixture in a plastified state,
d) mixing a physical blowing agent into the melt in a concentration of 0.1-2.3% by weight, based on the polymer melt, where the physical blowing agent is nitrogen, carbon dioxide or a mixture of these, preferably carbon dioxide,
e) particle foam extrusion of the plastified mixture at a melting temperature T of T₁=(T_{g}+110° C.) to T₂=(T_{g}+170° C.), preferably at T of T₁=(T_{g}+120° C.) to T₂=(T_{g}+160° C.), where T_{g} is the glass transition temperature of the aromatic polycarbonate-based composition,
f) pelletizing the blowing agent-containing melt, preferably in the form of unpressurized underwater pelletization.

The individual steps of the process of the invention can be performed using the tools and machines available in plastics technology that are known to the skilled person. It is also optionally possible here to conduct individual steps in combination.

The process for producing the polycarbonate beads can be performed continuously or batchwise. The polymer melt may, for example, be taken directly from the polymerization reactor as a freshly polymerized material or be guided therefrom directly into a mixing extruder in which chain extender, blowing agent and optionally additives are ultimately conducted at various points. The process of the invention is preferably conducted as a continuous process since there is the risk in a batchwise process control that the polycarbonate will crystallize out.

It will be apparent that the provisions according to the claims with regard to the ratio of the molar amounts of OH end groups of the polycarbonate and of the reactive group of the chain extender have to be adjusted in accordance with the process control. In a continuous procedure, there is appropriately a throughput-based adjustment of concentration (mol/h:mol/h ratio).

The process of the invention may be a one-stage or else a two-stage extrusion process in which, in a first extrusion step, the molecular weight of the polymer is increased in the presence of the chain extender and polycarbonate pellets are obtained as the first product and then, in a second extrusion step, the foaming with the physical blowing agent, preferably carbon dioxide, is effected; the result of the subsequent underwater pelletization is ultimately the polycarbonate beads of the invention. The first extrusion stage can then be concluded by a pelletization. For this purpose, the melt is extruded through a forming tool at an exit opening of the extruder and then cut to length. Cutting-to-length is accomplished by means of a cutting device which is typically directly downstream of the forming tool through which the material is extruded. The cutting device here may be in contact with the forming tool or may be disposed at a certain distance from the forming tool. However, the subsequent injection of blowing agent in the same extruder can also be carried out, either only after a certain residence time of the mixture of polycarbonate and chain extender, or at the same time as the supply of the chain extender.

The process of the invention allows production of polycarbonate beads, a particle foam. The use of particle-foamed polycarbonate, because of the low weight and the impact-resistant properties of the material, combined with higher continuous operating temperatures (stability, for example, in the cathodic electrocoating process) compared to PP, ABS, PE or PA6, makes it possible to significantly reduce the weight of some vehicle components, and also to reduce fuel consumption and CO₂ emissions, while the mechanical properties are maintained even at higher temperatures. In addition, it is to be expected that the availability of foamed polycarbonate will be able to open up a whole range of other field of application, especially where insulation functions are required at higher temperatures.

The invention thus also provides polycarbonate beads produced by the process of the invention. According to the invention, a “bead” means foamed pellets (=particle foam) which typically have a maximum density of not more than 50% of the unfoamed starting material (the aromatic polycarbonate-based composition). The polycarbonate beads obtainable by the process of the invention preferably have a molecular mass average, measured here as absolute molar mass, of the aromatic polycarbonate of at least 140 kDa (highly branched), more preferably at least 150 kDa, determined by GPC MALLS measurement (multi-angle laser light scattering) in accordance with DIN EN ISO 16014-5:2019-09. At the same time, the molar masses and also the molecular dimensions of the molecules are determined and conclusions are made therefrom as to the degree of branching of the materials, since the branching influences the separation mechanism of the GPC, which is apparent from the rising molar mass curve. The linear starting material is compared as reference for comparison with the foamed samples. The greater the branching (smaller hydrodynamic volume at the same molar mass) of the sample, the greater the deviation of the curve from the ideal line of an unbranched polycarbonate. Polycarbonate material, which has a corresponding minimum degree of branching, can be efficiently foamed, and accordingly leads to polycarbonate beads with good morphology, from which molded articles with good mechanical properties can be produced.

The particles of expanded polycarbonate, the “polycarbonate beads”, produced by the process of the invention have the following properties:
a bulk density, depending on the continuous process control, of 150 g/L to 250 g/L, preferably 180 g/L to 200 g/L, determined in the process via the bulk density on the basis of DIN EN ISO60:1999. What is meant here by “on the basis of” is that, rather than the standardized aluminum container with known volume, a 1 L beaker was filled and its contents were weighed to determine the density of the material.
a nominal diameter (depending on the process) in the range from 2 to 7 mm, preferably from 2.5 to 5 mm, more preferably of 3 mm+0.2 mm; the exact size distribution is preferably determined using a Camsizer;
the thermal properties (T_{g} of 145-150° C.) and mechanical properties of polycarbonate, for example at a component density of 200 kg/m³, of at least one bending modulus of 70 MPa, a flexural strength of 2.5 MPa (ISO 6603-2:2000); a compression modulus of 59 MPa and a compressive strength (at 10% compression) of 1.73 MPa (ISO 844-11:2014); a tensile strength of at least 1.97 MPa and an elongation at break of 8-14% (ISO 1926:2009);
an average equivalent circle diameter of the cells to the circle of equal projection area of not more than 150 μm, preferably of not more than 100 μm, more preferably of not more than 80 μm, determined by SEM (ASTM E1508-12a:2019).

The size of the beads depends on the process control and can be influenced by factors including the chosen nozzle size, throughput, blade speed and composition of the blowing agent-containing melt. An illustrative process control with a nozzle size of 1.2 mm affords beads with a nominal diameter in the range from 1.8 to 3 mm. The maximum of the frequency distribution is 2.5 mm with a distribution width of 28%, based on the mean. With a 2.2 mm nozzle, a particle size distribution with an average diameter of 5 mm and a distribution breadth of 40%, based on the mean, is obtained.

The polycarbonate beads are weldable within a wide range, preferably at a water vapor pressure of 7 bar to 11 bar, more preferably 8 bar to 10 bar. They have a high molecular weight M_{w} in the range from 40 000 g/mol up to 230 000 g/mol, determinable by GPC, as described in the examples.

The polycarbonate beads show good mechanical properties and low thermal conductivity (DIN EN 12667:2001) in the range of 45-47 mW/(m*K) at 10° C. and a component density of 200±10 kg/m³. The beads have intact (“closed-cell”) or at least predominantly intact cells, and therefore molded foam articles with very uniform, even surfaces and homogeneous welding of the beads can be produced from the polycarbonate beads. What is meant here by “predominantly” is that preferably >85% of the cells, more preferably >90% of the cells in a bead are intact, i.e. the individual cell structure in these beads is divided by at least three other structural elements (cells) and there are no more than two broken cell walls per single cell.

The starting material for the production of the beads of the invention in the process of the invention is an aromatic polycarbonate-based composition.

In the context of the invention, the term “polycarbonate” is considered to mean both aromatic homopolycarbonates and aromatic copolycarbonates. These polycarbonates may be linear or branched in a known manner.

The polycarbonates present in the compositions are produced in a known manner from dihydroxyaryl compounds, carbonic acid derivatives, and optionally chain terminators and branching agents.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. MGller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization process, by reacting dihydroxyaryl compounds with, for example, diphenyl carbonate. Preference is given in accordance with the invention to using polycarbonate that has been prepared by the melt polymerization process, also called “transesterification process”. Polycarbonate used in accordance with the invention has 350 to 600 ppm of OH end groups, this figure relating to the polycarbonate as such, to the polymer itself, without any additives. The amount of OH end groups is based on the total amount of polycarbonate used. It is also possible to use a mixture of polycarbonate that has been obtained by melt polymerization, and one obtained by the interfacial method, provided that the total concentration of the OH end groups in the polycarbonate used is within the specified range. Particular preference is given, however, using solely polycarbonate that has been prepared by the melt polymerization method.

Dihydroxyaryl compounds suitable for producing polycarbonates include for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

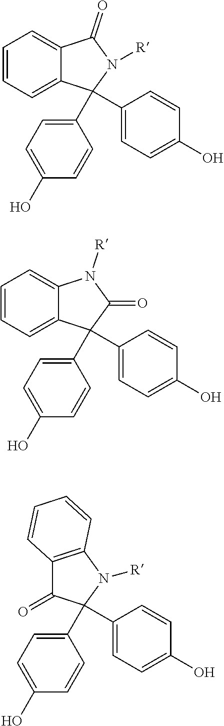

in which R′ in each case represents C₁- to C₄-alkyl, aralkyl or aryl, preferably methyl or phenyl, most preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,635 A, 2,999,825 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964”, and in JP 62039/1986 A, JP 62040/1986 A and JP 105550/1986 A.

In the case of homopolycarbonates only one dihydroxyaryl compound is used; in the case of copolycarbonates two or more dihydroxyaryl compounds are used.

Examples of suitable carbonic acid derivatives include phosgene or diphenyl carbonate.

Suitable chain terminators that may be employed in the production of the polycarbonates include monophenols. Examples of suitable monophenols include phenol itself, alkylphenols such as cresols, p-tert-butylphenol, isooctylphenol, cumylphenol, and mixtures thereof.

Preferred chain terminators are the phenols mono- or polysubstituted by linear or branched C₁- to C₃₀-alkyl radicals, preferably unsubstituted or tert-butyl-substituted. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and (III)

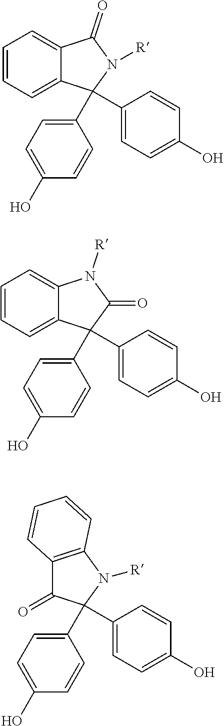

in which each R′ is C₁- to C₄-alkyl, aralkyl or aryl, preferably methyl or phenyl, very particularly preferably methyl,
   especially with bisphenol A. Most preferably, the polycarbonate-based compositions comprise bisphenol A-based polycarbonate; the polycarbonate in the polycarbonate-based compositions is exceptionally preferably bisphenol A-based homopolycarbonate.

Also preferred are copolycarbonates produced using diphenols of general formula (1a):

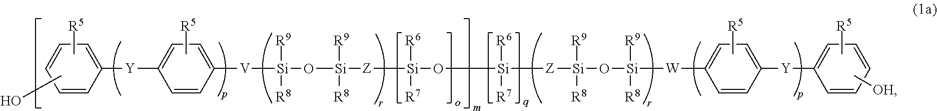

where
R⁵ is hydrogen or C₁- to C₄-alkyl, C₁- to C₃-alkoxy, preferably hydrogen; methoxy or methyl,
R⁶, R⁷, R⁸ and R⁹ are each independently C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or poly substituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0, W is a single bond, when q=1 and r=0, W is oxygen, C₂- to C₆-alkylene or C₃- to C₆-alkylidene, preferably oxygen or C₃-alkylene,
when q=1 and r=1, W and V are each independently C₂- to C₆-alkylene or C₃- to C₆-alkylidene, preferably C₃-alkylene,
Z is a C₁- to C₆-alkylene, preferably C₂-alkylene,
o is an average number of repeat units from 10 to 500, preferably 10 to 100, and
m is an average number of repeat units from 1 to 10, preferably 1 to 6, further preferably 1.5 to 5. It is likewise possible to use diphenols in which two or more siloxane blocks of general formula (1a) are joined to one another via terephthalic acid and/or isophthalic acid to form ester groups.

Especially preferred are (poly)siloxanes of formulae (2) and (3)

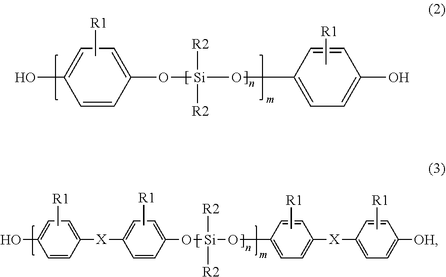

where R1 is hydrogen, C₁ to C₄ alkyl, preferably hydrogen or methyl, and especially preferably hydrogen,
R2 is independently aryl or alkyl, preferably methyl,
X is a single bond, —SO₂—, —CO—, —O—, —S—, C₁ to C₆ alkylene, C₂ to C₅ alkylidene or C₆ to C₁₂ arylene, which may optionally be fused with further aromatic rings containing heteroatoms,
X is preferably a single bond, C₁ to C₅ alkylene, C₂ to C₅ alkylidene, C₅ to C₁₂ cycloalkylidene, —O—, —SO—, —CO—, —S—, —SO₂—, more preferably X is a single bond, isopropylidene, C₅ to C₁₂ cycloalkylidene or oxygen, and very more preferably is isopropylidene,
n is an average number from 10 to 400, preferably 10 to 100, especially preferably 15 to 50, and
m is an average number from 1 to 10, preferably from 1 to 6 and especially preferably from 1.5 to 5.

The siloxane block may likewise preferably be derived from the following structure

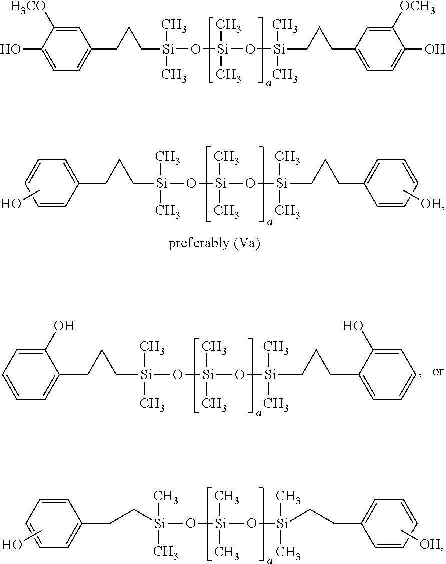

where a in formulae (IV), (V) and (VI) is an average number from 10 to 400, preferably 10 to 100 and particularly preferably 15 to 50.

It is likewise preferable when at least two identical or different siloxane blocks of general formulae (IV), (V) or (VI) are joined to one another via terephthalic acid and/or isophthalic acid to form ester groups.

It is likewise preferable when, in formula (1a), p=0, V is C₃-alkylene, r=1, Z is C₂-alkylene, R⁸ and R⁹ are methyl, q=1, W is C₃-alkylene, m=1, R⁵ is hydrogen or C₁- to C₄-alkyl, preferably hydrogen or methyl, R⁶ and R⁷ are each independently C₁- to C₄-alkyl, preferably methyl, and o is 10 to 500.

Copolycarbonates having monomer units of formula (1a) and in particular also the production thereof are described in WO 2015/052106 A2.

Copolycarbonates having monomer units of formula (IV) and in particular also the production thereof are described in WO 2015/052106 A2.

The aromatic polycarbonate used in the process of the invention may be a polycarbonate, but also a mixture of two or more aromatic polycarbonates, provided that the content of OH end groups of the entire polycarbonate used is within the inventive range. It is also possible to use polycarbonate which is a post-consumer or post-industrial recyclate. Appropriate recyclates can be fed to the extruder in the form of pellets or regrind. It is also possible to use recyclate only as a portion of the aromatic polycarbonate.

In principle, one or more additives may be added to the aromatic polycarbonate, and indeed directly to the polycarbonate as used as the starting material in the process of the invention. However, one or more additives can also be supplied to the aromatic polycarbonate only during the performance of the process of the invention in the extruder, preferably together with the chain extender. Incorporation via the side extruder is not possible in the process of the invention if only one extrusion stage is used, since the blowing agent is present in the melt and would accordingly escape via the side feed. However, a gas-tight side feed would enable the introduction of the additives in this way. Additives can also be introduced by means of powder premixes or as a masterbatch. Liquid additives can always be injected at any point in the process provided that sufficient homogenization is still possible, preferably in the region of static or dynamic mixing units. Additives can also be added in a first stage and the blowing agent then in a second stage. It is then also possible here to add the additives via a side extruder.

The mixture of aromatic polycarbonate, any blend partners and any additives as starting material is referred to as “aromatic polycarbonate-based composition”. The use of an “aromatic polycarbonate-based composition” in process step a shall thus be understood to mean the use of the pure polymer, but also the use of additized aromatic polycarbonate. If an additized polycarbonate composition is used, it preferably contains at least 70% by weight, further preferably at least 80% by weight, even further preferably at least 90% by weight, more preferably at least 95% by weight, most preferably up to 98% by weight, of aromatic polycarbonate, based on the total weight of the polycarbonate composition. It is exceptionally preferable that the “aromatic polycarbonate-based composition” does not contain any blending partners to the polycarbonate, but only aromatic polycarbonate is used in the process of the invention for producing polycarbonate beads, except for additives which may be customary for polycarbonate.

Such further additives as customarily added to polycarbonates are in particular heat stabilizers, flame retardants, antioxidants, mold release agents, anti-drip agents, for instance polytetrafluoroethylene (Teflon) or SAN-encapsulated PTFE (e.g. Blendex 449), UV absorbers, IR absorbers, impact modifiers, antistats, optical brighteners, fillers such as talc, quartz, light-scattering agents, transesterification inhibitors, compatibilizers, nucleating agents, colorants, pigments, e.g. titanium dioxide, carbon black, chemical blowing agents and/or additives for laser marking, especially in the amounts customary for polycarbonate-based compositions. Such additives are described for example in EP-A 0 839 623, WO-A 96/15102, EP-A 0 500 496 or in “Plastics Additives Handbook”, Hans Zweifel, 5th Edition 2000, Hanser Verlag, Munich. These additives may be added individually or else in admixture. It will be appreciated that it is only permissible to add such additives, and only in such amounts, if they do not have a significant adverse effect on the production of the beads by the process of the invention.

The additives are preferably selected from the group consisting of heat stabilizers, flame retardants, antioxidants, mold release agents, colorants, pigments, anti-drip agents, UV absorbers, IR absorbers, nucleating agents, impact modifiers, antistats, optical brighteners, light-scattering agents, transesterification inhibitors, compatibilizers and/or additives for laser marking.

The aromatic polycarbonate-based composition preferably has a melt volume flow rate MVR of up to 14 cm³/(10 min), further preferably up to 12 cm³/(10 min), more preferably from 5 cm³/(10 min) to 9 cm³/(10 min), most preferably from 5.5 cm³/(10 min) to 6.5 cm³/(10 min), determined according to ISO 1133:2012-3 (test temperature 300° C., mass 1.2 kg).

As part of the process of the invention, a sufficient amount of chain extender is added to the aromatic polycarbonate used that the molar ratio of the OH end groups of polycarbonate is 1:0.64 to 1.1, preferably 1:0.71 to 1.0, further preferably 1:0.96, even further preferably 1:0.8 to 0.9, in particular 1:0.82 to 0.90, of the reactive groups of the chain extender. The molar amount is preferably adjusted here on the basis of throughput per hour. This results in an increase in molecular weight of the polymer; the molecular weight of the aromatic polycarbonate is increased by the formation of long-chain branches.

Suitable chain extenders are in principle amines, carboxyl compounds, maleic anhydride-modified compounds, epoxy-functionalized compounds, oxazolines, carbodiimides and/or functionalized polymers, for instance based on acrylate and/or styrene, and having corresponding functional groups. Such compounds may be used alone or in a mixture. Such groups are, for example, amine functions in the amines, carboxyl functions in the carboxy compounds, anhydride functions in maleic anhydride-modified compounds, epoxy functions in epoxy-functionalized compounds or other functions that can react with the OH end groups of the polycarbonate so as to increase chain length. Preferred chain extenders are in particular epoxy-functionalized compounds, most preferably epoxy-functionalized styrene-acrylic-based polymers, which are supplied by BASF SE, for example, as Joncryl additives, e.g. Joncryl ADR 4368, ADR 4400, ADR 4468. The amount/weight of chain extenders has to be matched to the aromatic polycarbonate, such that 0.64 to 1.10 mol, preferably 0.71 to 1.0 mol, further preferably to 0.96 mol, even further preferably 0.8 to 0.9 mol, in particular 0.82 to 0.90 mol, of the reactive group of the chain extender can be used per 1 mol of OH end groups of the polycarbonate. Proceeding, for example, from an aromatic polycarbonate having 350-600 ppm of OH end groups, reacted with a chain extender having an epoxy equivalent weight of 310 g/mol, for example with Joncryl ADR 4468, in concentrations of 0.4-1.2% by weight, preferably 0.5-1.0% by weight, more preferably in concentrations of 0.7-0.9% by weight, where the amount of chain extenders is based on the resulting overall composition (aromatic polycarbonate-based composition, i.e. including any blend partners and any additives, plus chain extenders), the ranges of the reactive group ratios can be attained. By controlled establishment of the molar ratio of 1 mol:0.64 to 1.10 mol, molecular weight ranges of 40 000 to 230 000 g/mol, preferably 50 000 to 150 000 g/mol, more preferably 75 000 to 100 000 g/mol, determined as described, are attained. The broad processing window enables production of components from particles having molecular weights between 40 000 and 230 000 g/mol with different properties.

For performance of reactive particle foam extrusion, the following setup arrangements may be used, without limitation thereto:
a) polymerization reactor/(static) extruder/mixer/gas metering system/melt pump/pelletization
b) extruder (twin/single-screw)/gas metering system/pelletizer
c) extruder (twin/single-screw)/gas metering system/static mixer/pelletizer
d) extruder (twin/single-screw)/gas metering system/heat exchanger/pelletizer
e) extruder (twin/single-screw)/gas metering system/static mixer/heat exchanger/pelletizer
f) twin-screw extruder/gas metering system/single-screw extruder/pelletizer
g) twin-screw extruder/gas metering system/heat exchanger/pelletizer
h) twin-screw extruder/gas metering system/single-screw extruder/melt pump/pelletizer
i) twin-screw extruder/gas metering system/heat exchanger/melt pump/pelletizer.

The extrusion process can be conducted in one or two stages.

In detail, the process can be implemented in various arrangements. Important steps in the process are: melting of the aromatic polycarbonate-based composition, optionally addition of nucleating agents (talc, in particular nanoscale talc, graphite, carbon black, pigments etc.), dosage of the blowing agent via liquid dosing systems (for example from Lewa GmbH in Germany) or compression units (high-pressure units) (for example from Maximator GmbH in Germany), optionally pressure buildup up to the die plate via cooling, for example, addition of reactive macromonomers or via technical aids such as breaker plates or melt pumps (the pressure is preferably increased by adding reactive macromonomers or via utilization of technical aids), and lastly the chopping of the pellets/bead via pelletization in liquid medium, hot chopping or under-gas pelletization, where it is also possible to use gas mixtures. It should be noted that the liquid medium used here may not only be the medium of water, but also an alternative medium such as glycerin or glycerol.

Particular preference is given to performing the process of the invention using a tandem setup consisting of a twin screw and a single screw. In this case, the twin screw is further preferably used for plastification of the aromatic polycarbonate-based composition and for mixing the physical blowing agent and the chain extender, and the single screw thereafter for melt temperature control. The molecular weight is already increased in the twin screw/in the first extruder, and this continues until exit from the nozzle (end of the extrusion system).

The metered addition of the physical blowing agent to the melt containing the aromatic polycarbonate and the chain extender that reacts throughout the process is more preferably effected in the last third of the first extrusion unit (depending on the construction). The mixing is preferably effected in such a way that the polymer melt ultimately contains the blowing agent in homogeneous distribution, where the proportion of the physical blowing agent in the mixture for CO₂ is preferably 1.0% to 2.3% by weight, further preferably 1.2% to 1.7% by weight, more preferably 1.3-1.5% by weight, and for N₂ preferably 0.1% to 0.5% by weight, further preferably 0.1% to 0.3% by weight, more preferably 0.15% to 0.25% by weight and most preferably 0.15% to 0.2% by weight, based on the total weight of polymer melt (=polycarbonate-based composition) with chain extender. It should be noted that the process of the invention does not require step d to follow after step b. It is likewise possible that the mixing of the physical blowing agent into the melt commences simultaneously with or overlaps in time with the metered addition of the chain extender.

For initiation of foam cell formation for a finer and more homogeneous cell morphology, nucleating agents such as talc, in particular nanoscale talc, graphite, carbon black, pigments etc. are added in low concentrations of 0.1% to 1.0% by weight, further preferably 0.15% to 0.5% by weight, more preferably in concentrations of 0.2% to 0.3% by weight, where the amounts are based on the resulting overall composition of polycarbonate-based composition and chain extender.

In principle, physical blowing agents used may be any of the blowing agents commonly used for the foaming of thermoplastics. Examples here are propane, butane, n-pentane, isopentane, but also similar aliphatic hydrocarbons, including aromatic hydrocarbons, alicyclic hydrocarbons, aliphatic alcohols, carbon dioxide, nitrogen, air, inert gases such as argon or helium, and others. Combinations of two or more of these blowing agents can also be used as physical blowing agent. Preference is given to using carbon dioxide, one or more inert gases, nitrogen, air or mixtures thereof as physical blowing agents, since these are not only of no toxicological and environmental concern, but also do not promote fire. Very particular preference is given to nitrogen, carbon dioxide or a mixture of these, and the greatest preference to carbon dioxide.

If nitrogen is used as physical blowing agent, preferably 0.1% to 0.5% by weight, further preferably 0.1% to 0.3% by weight, more preferably 0.15% to 0.25% by weight and most preferably 0.15% to 0.2% by weight of nitrogen is used, based on the polymer melt including chain extenders and additives (i.e. polycarbonate-based composition plus chain extenders).

If carbon dioxide is used as physical blowing agent, preferably 1.0 to 2.3% by weight, more preferably 1.2% to 1.7% by weight, more preferably 1.3 to 1.5% by weight of carbon dioxide is used, based on the polymer melt including chain extenders and additives.

In the production process, using the example here of a tandem plant, setup h), various physical blowing agents can be introduced into the polymer melt at various points, for example by means of liquid metering or high-pressure metering. Physical blowing gases are preferably added to the first extruder, but to the last third of the extruder for the best possible homogenization. Metered addition at the end of the tandem plant would likewise enable particles, but the operation would be more unstable and the resulting particles inhomogeneous. Most preferably, the blowing agent used is carbon dioxide, since it has the advantage of being non-combustible by comparison with the other blowing agents that are used in the production of expanded thermoplastics and is additionally available at lower cost compared to the inert gases and nitrogen. Furthermore, it can be comparatively easily converted to the supercritical state (T>31.0° C. and p>73.8 bar), which promotes miscibility and dissolution in polycarbonate through low compressibility and rapid diffusivity. The polycarbonate beads of the invention, in the case of use of carbon dioxide as blowing agent in the production process of the invention, can thus be used even without concerns in respect of components that are used in applications that involve a certain fire risk or must not outgas (interior). In particular, there are thus also conceivable applications in the field of e-mobility, for since as bodywork components, for example for composite parts. Possible applications here are in particular noise-absorbing elements that are integrated into the vehicle's floor area or insulating layers in the bodywork.

The melt pressure has to be chosen such that it is above the critical dissolution pressure of the physical blowing agent.

The melt is extruded at the exit opening of the extruder through a nozzle plate after blowing agent has been mixed in and dissolved, generally at a temperature of the melt T of T₁=(T_{g}+110° C.) to T₂=(T_{g}+170° C.), preferably of T₁=(T_{g}+120° C.) to T₂=(T_{g}+160° C.), more preferably in the range from T₁=(T_{g}+130° C.) to T₂=(T_{g}+150° C.). The temperature of the nozzle plate is additionally preferably set to a temperature of T_{g}+(130 to 150° C.) in order to prevent freezing of the nozzle by cooling polymer melt and hence to ensure the constant polymer pelletization, and to achieve corresponding foam expansion with maximum potential for expansion.

The diameter of the nozzle opening for a single-hole nozzle is preferably in the range from 0.8 to 2.2 mm, preferably 1.0 to 1.5 mm. For multi-hole nozzles, nozzle diameters from 0.4 to 0.8 mm are preferred, more preferably of 0.6 mm.

The pelletizing of the melt on conclusion of the process of the invention is preferably effected by underwater pelletization and further preferably without additional pressurization, i.e. at atmospheric pressure. Pelletization at atmospheric pressure can achieve the desired low densities of the polycarbonate beads. As the melt exits the nozzle, the polycarbonate material experiences a pressure drop of 140 to 180 bar, preferably of 150-160 bar, to the atmospheric pressure of about 1 bar, which causes the material to start to foam. The physical blowing agent, for example carbon dioxide, inflates the polycarbonate material while the gas is diffusing out of the polymer melt. After a certain time, complete or nearly complete exchange of gas has taken place, such that only the normal air composition can be found in the expanded polycarbonate which is then in pelletized form, the polycarbonate beads.

The invention also provides a process for producing molded articles from the polycarbonate beads that have been produced by the process of the invention, and such molded articles.

The polycarbonate beads can be converted by filling of corresponding cavities to molded articles, even those with complex geometries, ultimately requiring only one corresponding step. There is no need for subsequent cutting-to-size, known from extrusion foams, which is frequently still required, with corresponding formation of waste. Polycarbonate beads are additionally easier to transport than the often bulky sheets of available extrusion foams.

Corresponding molded articles of the invention can be employed in the automotive industry, in transportation, in the construction industry, the aviation industry, the aerospace industry, in the packaging industry, and generally in lightweight construction and/or composite construction. Possible molded articles made of the polycarbonate beads are not only sheets, but also complex, three-dimensional parts.

Molded articles consisting of or comprising the polycarbonate beads of the invention are in particular visible parts in various fields of application, although upgrading with laser textures is also possible, for instance dashboards or interior trim elements, sound insulation elements, infill elements, for example in carpets in a car footwell, a core material or supporting foam part of composite materials, for instance for bodywork insulation for vehicles, especially electric vehicles, in the HVAC field (heating, ventilation, air conditioning) as insulation material, as high-temperature insulation in industry, in housing and building technology or in transportation, barrier and insulation materials, packaging, lightweight construction elements, wind turbine blades, facade components.

In general, molded articles made of polymer foams are primarily subject to compressive stress. Another relevant type of stress for polymer foams is bending. The component is subjected here to a complex load in that the top side is subjected to compressive stress and the bottom side is subjected to tension. Pressure tests enable a conclusion as to the application-relevant mechanical performance, and also tensile tests and bending tests relating to the welding quality. The components made from the polycarbonate beads obtained by the process of the invention may have a thermo-mechanical (T_{g} of 145-150° C.) profile of polycarbonate, for example at a component density of 200 kg/m³, of a bending modulus of 59.1±11.4 MPa, a flexural strength of 2.2±0.3 MPa (at 23° C., ISO 1209-1:2007, modified geometry to 120×25×10 mm³); compression modulus of 54.7±5 MPa and a compressive strength (at 10% compression) of 1.61±0.12 MPa (at 23° C., DIN EN ISO 844-11:2014); a tensile strength of at least 1.97 MPa and an elongation at break of 8.4% (DIN EN ISO 1926:2009) with a simultaneously good insulation effect of 45.2±2 mW/(m K) at 10° C. (EN ISO 8301-8:1991). The commercial particle foam EPP, at the same density of 200 kg/m³, has about a bending modulus of 56.1±10.8 MPa, a flexural strength of 1.85±0.25 MPa, a compression modulus of 48.4±3.6 MPa and a compressive strength (at 10% compression) of 1.51±0.5 MPa. In addition, EPP has a tensile strength of 2.49 MPa and an elongation at break of 20.2% with a simultaneous insulation effect of 54±0.2 mW/(m*K) (10° C.), where these values are determined as described above for the EPC, which is a notably lower performance.

Because the polycarbonate beads are quite large in some cases, with mean diameters equivalent to a circle of equal projection area, i.e. nominal diameters, of about 4 to 6 mm, it is necessary, however, to overfill the cavity in the mold by 10-20% based on volume. The steam-based welding process for particle foams proceeds according to the same mechanism for all particles and is described extensively in the literature, for example in Raps et al. 2015; DOI: 10.1016/j.polymer.2014.10.078.

For production of molded articles/components, foam particles are welded together in a water vapor molding machine or by variothermal means (thermally by heating). In a water vapor molding machine, the particle surface is partly melted or softened using high-pressure water vapor (i.e. water vapor at high temperature), which leads to interdiffusion of polymer chains between different beads and the resulting cohesion of the beads. Good cohesion between the particles and a low proportion of macropores/interstices, i.e. cavities between particles in the component owing to poor packing, are necessary in order to ensure favourable mechanical properties. The processing of foam beads to the finished part is effected in a molding machine in five steps: 1) complete or partial closing of the mold, 2) filling of the mold, followed by complete closure if necessary, 3) welding of the particles, 4) cooling and stabilization, 5) ejection of the molded article. Two methods are distinguished here: the crack gap method and the pressure filling method. In the pressure filling method, the mold is first closed, then the particles are drawn out of a container by air pressure and blown into the mold by an injector at about 3 bar and compressed therein. The particles expand in the mold and fill the cavities better (corresponding to an overfill of about 10% in the crack gap method). In the crack gap method, the mold is not closed completely, but a certain gap (%) remains open. The mold is then filled with particles, such that the mold is overfilled to a certain percentage (10-20% by volume for EPC). The mold is then closed and the particles are compressed to target thickness. If the target thickness of the component is, for example, 20 mm, the mold cavity is opened further for filling, for example 4 mm (=20% by volume), and filled with the polycarbonate beads, and then the mold is contracted to a component thickness of 20 mm. This step is crucial in order to achieve a homogeneous distribution of the beads in the mold. In the third step, the beads are fused together by steam flowing through the mold by a fixed procedure. During steaming, the beads form physical bonds owing to the interdiffusion of polymer chains of adjacent particles. In order to ensure a high quality of welding between the particles, preferably 7 to 11 bar, more preferably 8 to 10 bar, has to be employed for EPC. In the steam-based welding process, the air between the beads is first flushed out and the mold is preheated. Steam flows in parallel to the mold when the valves are open. In the second step, the steam flows through the mold, which is referred to as cross-steaming. During this step, the mutually opposite steam inlet and outlet valves are open. In order to ensure a very homogeneous temperature distribution and uniform welding quality throughout the part, the mold is preferably steamed from both sides. Finally, with the outlet valves closed, steam is directed into the steam chamber at a particular pressure in order to improve the surface quality by formation of a skin (autoclave steaming). In the fourth step, the molded article is cooled, which is crucial for dimensional accuracy. If the part is ejected without cooling, further expansion of the particles is possible, resulting in a deviation from the original dimensions. For cooling, the mold is sprayed with water until a temperature of about 80° C. has been attained. After forming and cooling, the part is ultimately ejected in the last step, preferably by compressed air and mechanical ejectors.

The invention is illustrated by the figures that follow.

The figures show:

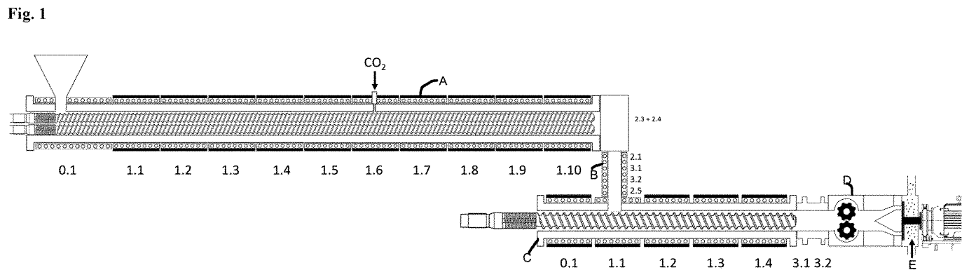

FIG. 1: Flow diagram of the process of the invention for producing polycarbonate beads.

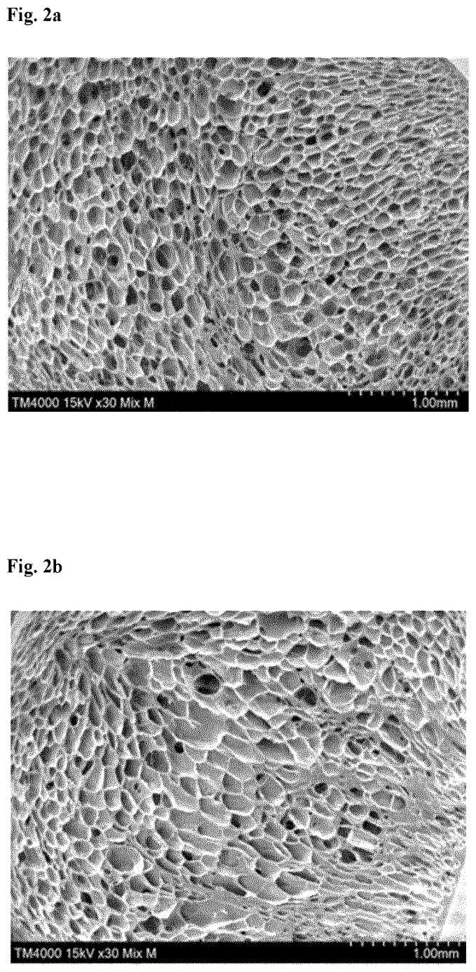

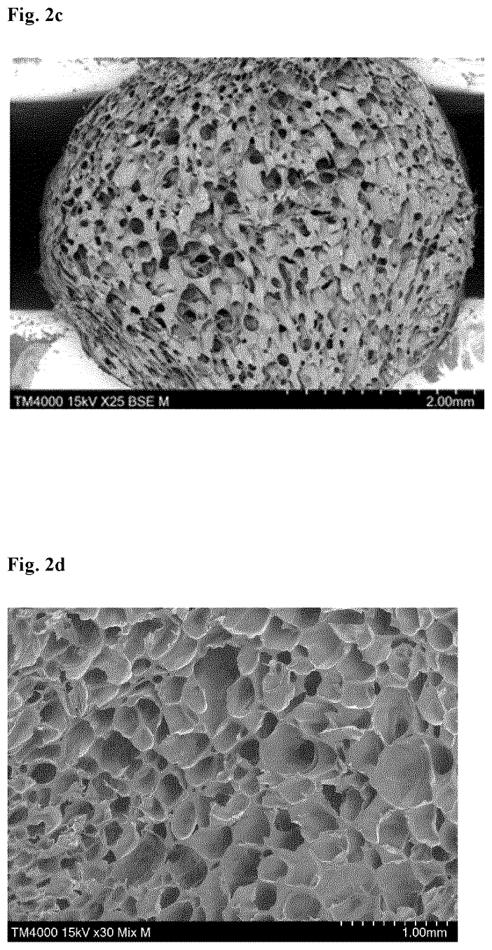

FIG. 2a: SEM image of the foam morphology of a polycarbonate bead obtainable by the process of the invention (molar reactive group ratio OH:epoxy of 1 mol:0.82 mol for a PC-1 component with an OH end group content of 470 ppm (E1)). The OH end group content, based on the total weight of the aromatic polycarbonate used, was 470 ppm.

FIG. 2b: SEM image of the foam morphology of a further polycarbonate bead obtainable by the process of the invention (molar reactive group ratio OH:epoxy of 1 mol:0.90 mol (based on throughput per hour) for a PC-1 component with an OH end group content of 470 ppm (E2)). The OH end group content, based on the total weight of the aromatic polycarbonate used, was 429 ppm.

FIG. 2c: SEM image of the foam morphology of a noninventive polycarbonate bead (molar reactive group ratio OH:epoxy of 1 mol:1.12 mol (based on throughput per hour) for a PC-1 component with an OH end group content of 470 ppm (V4)). The OH end group content, based on the total weight of the aromatic polycarbonate used, was 346 ppm.

FIG. 2d: SEM image of the foam morphology of a further noninventive polycarbonate bead (molar reactive group ratio OH:epoxy of 1 mol:1.47 mol (based on throughput per hour) for a PC-1 component with an OH end group content of 470 ppm (V6)). The OH end group content, based on the total weight of the aromatic polycarbonate used, was 264 ppm.

The system for performance of the process of the invention shown in FIG. 1 is a tandem setup. This firstly consists of a co-rotating twin-screw extruder (A). The screws are optimized for the foaming process (e.g. two dextrorotatory elements for gas-tightness in intake direction). The twin-screw extruder has 10 heated zones with appropriate temperature monitoring and pressure detection in the illustrative diagram, with the metering of gas in this example at position 1.6. After the melt has been homogenized, it is forcibly conveyed into the single screw (C) via the bypass (B). The single-screw extruder here has 4 heatable zones with appropriate temperature monitoring and pressure sensors. The gas-melt mixture is primarily conveyed to the melt pump and kept at the same temperature in this process. The subsequent melt pump (D) has the function of generating a backpressure in the upstream system (better gas solubility) and of controlling the pressure upstream of the die plate. The homogenized melt is pushed through the die plate, foams up and is separated off by a rotating blade and transported away from the water circuit (E) (dried and separated).

FIGS. 2a to 2d show SEM images of morphologies of different polycarbonate beads produced by the process steps of the process of the invention, but at different molar ratios of OH end groups of the polycarbonate:epoxy groups of the chain extender (“OH to epoxy”). While aromatic polycarbonate was used in the production of the beads from FIGS. 2a and 2b in which the molar OH:epoxy ratio is within the range of the invention, this does not apply to the materials from FIGS. 2c and 2d. Here the molar OH:epoxy ratio of the formulation used was 1:1.12 or 1.47. In the case of these comparative beads, the partly destroyed cell morphology and cell coalescence is clearly apparent. The result is a material that cannot be processed to molded articles having good mechanical properties. However, the polycarbonate beads of the invention, produced by the process of the invention, have very substantially intact foam cells, with a distinct improvement in the quality of the foam structure within the particularly preferred range of reactive group equivalents of the formulation.

### EXAMPLES

### 1. Description of Raw Materials and Test Methods

### a) Raw Materials

### Polymers:

PC1: An aromatic polycarbonate based on bisphenol A, having an MVR of 6 cm³/(10 min) (300° C./1.2 kg, ISO 1133-1:2011) and a softening temperature (VST/B 120; ISO 306:2013) of 149° C. T_{g}, determined in accordance with DIN EN ISO 11357-1:2017: 148° C. M_{w}, determined as described below, about 30 900 g/mol at 28 kDA (MALLS). Containing 0.06% thermal stabilizer and 0.1% UV stabilizer. OH end group content determined by ¹H NMR spectroscopy with dichloromethane as solvent at room temperature (as described above): 470 ppm.

Produced via the melt condensation (SPC) process.

PC2: An aromatic polycarbonate based on bisphenol A, having an MVR of 6 cm³/(10 min) (300° C./1.2 kg, ISO 1133-1:2011) and a softening temperature (VST/B 120; ISO 306:2013) of 150° C. T_{g}, determined in accordance with DIN EN ISO 11357-1:2017: 148° C. M_{w}, determined as described below, about 30 900 g/mol at 28 kDA (MALLS). OH end group content determined by ¹H NMR spectroscopy with dichloromethane as solvent at room temperature (as described above): 60 ppm.

Produced via the interfacial condensation (LPC) process.

Chain extender 1: A commercially available and multifunctional chain extender from BASF SE (Joncryl ADR 4468) based on styrene/acrylic-based polymer comprising reacting epoxy groups and having an average molecular weight (gel permeation chromatography in ortho-dichlorobenzene at 150° C. with polystyrene calibration) M_{w}=7250 g/mol, an epoxy equivalent weight of 310 g/mol, determined in accordance with DIN EN 1877-1:2000-12, a glass transition temperature T_{g} of 59° C. and a decomposition temperature of 350° C., determined in accordance with DIN EN ISO 11357-1:2017.

### b) Process Procedure for the Examples

The process of the invention can in principle be performed by means of various machine setups as already described above. The tests described hereinafter were conducted using the setup i), ii), iii): twin-screw extruder-gas metering system-single-screw extruder-melt pump-underwater pelletization, also shown in FIG. 1. Example i) describes a successful particle production within the scope of the claims, example ii) describes a failed particle production as a result of exceedance of the maximum concentration of chain extender, example iii) describes a failed particle production as a result of absence of the reactive component, example iv) describes a test series with the same setup and process parameters as in i), but with gradual reduction of the OH concentration of the melt (ppm) of PC with a constant reactive component, and example v) describes a successful particle production using an alternative setup of twin-screw extruder-static mixer/heat exchanger-melt pump-underwater pelletization.
i) A twin-screw extruder from Reifenhauser (Troisdorf, Germany) with 43 D was run with a throughput of 35 kg/h, at profile temperatures of 100-160° C. (positions 1 to 3), 240° C. (position 4) to 280° C. (positions 5-10) and a speed of 100 rpm. In addition, chain extender 1 was added to the PC1 melt in a low concentration of 0.7% by weight. This corresponds to a molar OH:epoxy ratio of 1:0.82 (mol/mol). The melt temperature was 10-20° C. higher than the housing temperature. The blowing agent was fed in by means of a Maximator (Maximator GmbH, Germany) and/or by means of a metering station (Lewa GmbH, Germany) at position 6 at a level of 1.2% to 1.5% by weight of CO₂. From position 5, the pressure profiles in the twin screw gradually rose from 45 bar up to the top of the extruder at 310 bar. The melt was conveyed via the transfer tube (290° C.) into the single-screw extruder (Reifenhauser). The extruder was likewise operated at a continuous housing temperature of 280° C., a throughput of 35 kg/h and a speed of 26 rpm. The melt pressure gradually dropped through the screw as far as the melt pump (from 250 to 120 bar). The melt pump was operated under pressure control at a backpressure of 110 bar and a temperature of 280° C. The pressure downstream of the melt pump was in the range of 160-180 bar (pressure at the die plate) in this process. The diverter and the die plate were likewise set to a temperature of 280° C. and the melt temperature was (T_{g}+140° C.) to (T_{g}+150° C.). The UWP (EUP 50) and the die plate were manufactured by ECON (Econ GmbH, Austria). The die plate consisted of 5 single-hole inserts with a diameter of 2.2 mm and a die land of 3.49 mm. The dwell time of the melt between intake and exit was about 7-10 minutes. Downstream of the exit, the melt was separated off with a rotating 6-blade knife at 1500 rpm and transported away by a water circuit at 70-80° C. (28 m³/h). The resultant particles were roundish with a bulk density of 150-180 g/L and were weldable efficiently in the range of 8-10 bar.
ii) A twin-screw extruder from Reifenhauser (Troisdorf, Germany) with 43 D was run with a throughput of 17 kg/h, at profile temperatures of 160-240° C. (positions 1 to 3), 260-270° C. (positions 4 and 5) to 280° C. (positions 6-10) and a speed of 86 rpm. In addition, chain extender 1 was added in a high concentration of 1.5% by weight. This corresponds to a reactive group ratio of OH:epoxy of 1 mol:1.78 mol. The melt temperature was 10-20° C. higher than the housing temperature. The blowing agent was fed in by means of a Maximator (Maximator GmbH, Germany) and/or by means of a metering station (Lewa GmbH, Germany) at position 6 at a level of 2% to 2.3% by weight of CO₂. From position 5, the pressure profiles in the twin screw gradually rose from 67 bar up to the top of the extruder at 250 bar. The melt was conveyed via the transfer tube (290° C.) into the single-screw extruder (Reifenhauser). The extruder was likewise operated at a continuous housing temperature of 280° C., a throughput of 17 kg/h and a speed of 15 rpm. The melt pressure gradually dropped through the screw as far as the melt pump (from 250 to 115 bar). The melt pump was run under pressure control at a backpressure of 110 bar and a temperature of 280° C. The pressure downstream of the melt pump was 230 bar (pressure at the die plate) in this process. The diverter was likewise set to a temperature of 280° C., and the die plate to 320° C. The melt temperature was (T_{g}+150° C.) to (T_{g}+160° C.). As a result of overdosage of the reactive component, it was necessary to distinctly reduce the throughput and increase the die plate temperature in order to prevent an emergency shutdown owing to critical system pressure. The UWP (EUP 50) and the die plate were manufactured by ECON (Econ GmbH, Austria). The die plate consisted of 5 single-hole inserts with a diameter of 2.2 mm and a die land of 15 mm. The dwell time of the melt between intake and exit was about 7-10 minutes. Downstream of the exit, the melt was separated off with a rotating 6-blade knife at 1500 rpm and transported away by a water circuit at 70-80° C. (28 m³/h). The manufacturing process was unstable and resulted in collapsed and shrivelled particles (bulk density >500 g/L) that were not weldable.
iii) A twin-screw extruder from Reifenhauser (Troisdorf, Germany) with 43 D was run with a throughput of 15 kg/h, at profile temperatures of 160-240° C. (positions 1 to 3), 260-270° C. (positions 4 and 5) to 280° C. (positions 6-10) and a speed of 85 rpm. This test series was conducted without chain extender. The melt temperature was 10-20° C. higher than the housing temperature. The gas was fed in via Maximator (Maximator GmbH, Germany) and/or by means of a metering station (Lewa GmbH, Germany) at position 6 at a level of 2% to 2.3% by weight of CO₂. From position 5, the pressure profiles in the twin screw gradually rose from 73 bar up to the top of the extruder at 94 bar. The melt was conveyed via the transfer tube (290° C.) into the single-screw extruder (Reifenhauser). The extruder was likewise operated at a continuous housing temperature of 280° C., a throughput of 15 kg/h and a speed of 15 rpm. The melt pressure gradually dropped through the screw as far as the melt pump (from 94 to 87 bar). The melt pump was run under pressure control at a backpressure of 110 bar and a temperature of 280° C. The pressure downstream of the melt pump was 90 bar (pressure at the die plate) in this process. The diverter and the die plate were set to a temperature of 280° C. and the melt temperature was (T_{g}+140° C.) to (T_{g}+150° C.). The process control was kept as close as possible to ii) in spite of the lack of a reactive component. The UWP (EUP 50) and the die plate were manufactured by ECON (Econ GmbH, Austria). The die plate consisted of 5 single-hole inserts with a diameter of 2.2 mm and a die land of 15 mm. The dwell time of the melt between intake and exit was about 7-10 minutes. Downstream of the exit, the melt was separated off with a rotating 6-blade knife at 1500 rpm and transported away by a water circuit at 70-80° C. (28 m³/h). The production process was not possible under the given conditions and resulted in barely expanded round particles with a very high density of 500-600 kg/m³. These had very poor to zero weldability to give components.
iv) A twin-screw extruder from Reifenhauser (Troisdorf, Germany) with 43 D was run with a throughput of 35 kg/h, at profile temperatures of 100-160° C. (positions 1 to 3), 240° C. (position 4) to 280° C. (positions 5-10) and a speed of 100 rpm. In addition, chain extender 1 was added in a fixed concentration of 0.7% by weight. In this series, by means of a different proportion of a second polycarbonate, the molar reactive group ratio OH:epoxy was varied between 1:0.82 and 1:1.47 (OH:epoxy, in each case in mol) (tab. 1). The melt temperature was 10-20° C. higher than the housing temperature. The blowing agent was fed in by means of a Maximator (Maximator GmbH, Germany) and/or by means of a metering station (Lewa GmbH, Germany) at position 6 at a level of 1.3% by weight of CO₂. From position 5, the pressure profiles in the twin screw gradually rose from 45 bar up to the top of the extruder at 270 bar for 100% by weight of SPC. As a result of addition of a PC component low in OH end groups, PC-2, the pressure profiles at first rose slightly to 275 bar at a level of 10%. Further addition of PC component low in OH end groups beyond 20% by weight led to declining pressure profiles. The melt was conveyed via the transfer tube (290° C.) into the single-screw extruder (Reifenhauser). The extruder was likewise operated at a continuous housing temperature of 280° C., a throughput of 35 kg/h and a speed of 26 rpm. The melt pump was run under pressure control at a backpressure of 110 bar and a temperature of 280° C. The pressure downstream of the melt pump was determined by the content of the reactive polycarbonate and was reduced by the extrinsic matrix content (shown in detail in tab. 1). The diverter and the die plate were likewise set to a temperature of 280° C. and the melt temperature was T_{g}+140° C. to T_{g}+150° C. The UWP (EUP 50) and the die plate were manufactured by ECON (Econ GmbH, Austria). The die plate consisted of 5 single-hole inserts with a diameter of 2.2 mm and a die land of 3.49 mm. The dwell time of the melt between intake and exit was about 7-10 minutes. Downstream of the exit, the melt was separated off with a rotating 6-blade knife at 1500 rpm and transported away by a water circuit at 70-80° C. (28 m³/h). The roundness of the particles gradually decreased, and foam density increased.
   In the case of too low a concentration of polycarbonate at OH end groups, specifically <350 ppm, the production process breaks down with a molar reactive group ratio (OH:epoxy, each in mol) of 1:1.12 (outside the scope of the claim). The increase in molecular weight no longer takes place to a sufficient degree, and so the viscosities of the melt mixture and hence the pressures at the die plate are no longer sufficient for a homogeneous particle foam. The resulting particles have a more elongated shape and an inhomogeneity in shape and appearance (as a result of lower viscosity and hence altered flow properties) at higher foam densities (lower pressure drop) (tab. 2). The particles can no longer be welded sufficiently well within the claimed pressure range of 7-11 bar. The components do not have a continuous surface and have many sink points/cavities, which results in poorer thermal conductivity, elevated rigidity, distinctly reduced maximum flexural strain and poorer puncture performance (tab. 2 and tab. 3).
v) A Coperion ZSK 26 MC twin screw extruder with 44 D was run with a throughput of 20 kg/h at housing temperatures of 280° C. (from the melting zone) and a torque of 60% and a speed of 230 rpm. In addition, chain extender 1 was added in low concentrations of 0.9% by weight. This corresponds to a molar reactive group ratio OH:epoxy of 1:0.9-1.1 for a PC component in the composition with a particularly preferred OH end group content of 450 to 550 ppm and is thus within the range of the invention. In housing 7 of 10 of the twin screw, the blowing agent CO₂ was introduced in concentrations of 1.2% up to 1.5% by weight via a gas metering station (Promix Solutions GmbH, Germany). The melt temperature of the gas-polymer mixture was 280° C. (=T_{g}+130° C.). The homogenized gas-polymer mixture was forcibly conveyed into the static mixer. The dwell time in this mixer was 6-8 minutes. The mixer was likewise operated with a profile temperature of 280° C. At the end of the static mixer, a melt pump from Maag-Germany GmbH regulated the backpressure at the inlet of the melt pump to 90 bar. The pressure upstream of the die plate was 198 bar. The melt was pelletized with an underwater pelletizer (from Gala). The gas-melt mixture was pushed through a die plate with 2 holes into the water-filled cutting chamber. The hole diameter of the holes in the die plate was 2.4 mm. In the cutting chamber, the melt was cut into pellets by rotating blades. The blade speed was 3500 rpm. The pressure drop beyond the die plate caused the pellets to foam. A pressure of 2 bar was applied to the process water at 80-90° C. that flowed through the cutting chamber. The pellets were finally dried and separated in a centrifuge. The resultant particles were round, had a smooth homogeneous surface with a bulk density of 220-250 g/L and were very efficiently weldable.

### c) Test Methods

The particles produced were processed by a Teubert TVZ162/100PP molding machine (Teubert Maschinenbau GmbH, Germany) to give components having a density of 200±10 kg/m³ and a geometry of 300×200×15 mm³. The necessary pressure for the welding for EPC was in the range of 7 to 10 bar. Finally, the properties of the components were determined. Scanning electron microscopy measurements (SEM, model: JEOL JSM-6510, Borken, Germany) was performed here with graphite-sputtered samples in order to visualize the morphology. A dynamic-mechanical analysis (DMA) was performed on a Gabo Eplexor 500N from NETZSCH GmbH, (Selb, Germany) in pressure mode on 15×15×15 mm³ samples in the temperature range of −25 to 250° C. at a heating rate of 1 K/min in pressure-regulated mode with an amplitude of 5% (static) and 2% (dynamic) of the sample height at a frequency of 1 Hz. Mechanical characterization was performed using pressure tests, tensile tests and 3-point bending tests (room temperature, 80 and 110° C.) and puncture tests (RT). Pressure tests were conducted in accordance with DIN EN ISO 844:2014-11 up to 60% compression on a Zwick Z020 universal tester from Zwick & Roell (Ulm, Germany) on samples with a geometry of 15×15×15 mm³ and with a 10 kN load cell. 3-point bending was conducted on the basis of ISO 1209-1:2007-05 with the same universal tester at 10 mm/min and a 20 kN load cell. The samples were skinned in order to eliminate the effect of the compact boundary layer, and the geometry was adjusted to 120×25×10 mm³. Tensile measurements on the components were conducted in accordance with ISO 1926:2009 on a Zwick Z050 universal tester (Zwick & Roell, Ulm, Germany) with a sample geometry of 140 (30+80+30)×80×15 mm³ and a 20 kN load cell. Puncture characterization was effected with a Fractovis Plus drop bolt tester from Instron Ceast (Pianezza, Italy) with a maximum energy of 40 J and a puncture speed of 4.4 m/s (in accordance with DIN EN ISO 6603-2:2002-04) with a sample geometry of 60×60×15 mm³. All mechanical characterizations were performed at room temperature, 80° C. and 110° C., in each case with a 10 min intermediate step for temperature adjustment prior to the measurement. All components were analyzed at the same density around 200 kg/m³. Thermal conductivity measurements were conducted on a HFM 446 Lambda instrument from NETZSCH (Selb, Germany) at −10° C., 10° C., 25° C., 50° C. and 70° C.

The average molecular weight Mw in the case of PC-1 and PC-2 was determined by gel permeation chromatography. Calibration was effected against bisphenol A polycarbonate standards, using dichloromethane as eluent. Calibration with linear polycarbonates (formed from bisphenol A and phosgene) of known molar mass distribution from PSS Polymer Standards Service GmbH, Germany, calibration by method 2301-0257502-09D (2009, German language) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 mm to 20 mm. Concentration of solutions: 0.2% by weight. Flow rate: 1.0 ml/min, temperature of solutions: 30° C. Injection volume; 100 ml. Detection by means of UV detector. In the case of the highly branched polycarbonate formed by increasing the molecular mass, via addition of a chain extender, the determination was effected by means of GPC MALLS, as described further up. It was not possible to dissolve all highly branched/partly crosslinked fractions (XYZ % insoluble), and so fractions of high molecular weight in particular cannot be characterized with existing analysis options. This is a problem known to a person skilled in the art, and so the accuracy of determination of molar mass in highly branched polymers is limited. The aforementioned molar mass ranges relate correspondingly to the dichloromethane-soluble components.

The OH number of the polymers was ascertained by ¹H NMR spectroscopy with dichloromethane as solvent at room temperature by evaluating the ratio of the integrals of the signals at 6.68 ppm (2 aromatic protons in ortho positions to phenolic OH groups) and at 1.68 ppm (6 methyl protons of the bisphenol A unit).

### 2. Results

### Compositions and Analysis

TABLE 1
Detailed compositions and analytical results of the
study of the molar ratio according to example iv)

| | E-1 | E-2 | E-3 | V-4 | V-5 | V-6 |
|---|---|---|---|---|---|---|
| PC1 [% by wt.] | 99.3 | 89.3 | 79.3 | 69.3 | 59.3 | 49.3 |
| PC2 [% by wt.] | 0 | 10 | 20 | 30 | 40 | 50 |
| PC1 throughput [g/h] | 34760 | 31280 | 27810 | 24330 | 20806 | 17380 |
| Pressure at end of A extruder | 270 | 275 | 250 | 288 | 189 | 176 |
| [bar] | | | | | | |
| Pressure at die plate [bar] | 190 | 184 | 177 | 170 | 134 | 122 |
| OH group content, based on | 470 | 429 | 387 | 346 | 305 | 264 |
| total weight of aromatic | | | | | | |
| polycarbonate [ppm] | | | | | | |
| Molar ratio of reactive OH | 0.82 | 0.90 | 1.00 | 1.12 | 1.27 | 1.47 |
| group (PC) to reactive group of | | | | | | |
| the chain extender (1:x) | | | | | | |
| M_{w} from GPC [g/mol] | 50180 | 52870 | 95690 | 93175 | 71691 | 50210 |
| M_{w} from GPC MALLS [kDa] | 158 | 168 | 206 | 207 | 139 | 107 |
| Particle density [kg/m³] | 197 | 234 | 265 | 271 | 260 | 253 |
| Average cell diameter [μm] | 100 ± 47 | 129 ± 77 | 139 ± 66 | 193 ± 99 | 193 ± 117 | 206 ± 134 |
| Cell density [cells/cm³] | 8.88 · 10⁵ | 4.12 · 10⁵ | 3.48 · 10⁵ | 1.47 · 10⁵ | 1.33 · 10⁵ | 1.18 · 10⁵ |
| Cell coalescence | no | no | no | yes | yes | yes |

TABLE 2
Detailed indices from the pressure tests, bending
tests and puncture tests for the comparative study in
example iv) of the EPC particle foam components

| | EPC (E-1) | EPC (V-4) |
|---|---|---|
| Component density [kg/m³] | 200 ± 10 | 230 ± 15 |
| Compression modulus [MPa] | 54.7 ± 5 | 50.9 ± 5.2 |
| Compressive strength at 10% | 1.61 ± 0.12 | 1.90 ± 0.14 |
| compression [MPa] | | |
| Flexural modulus [MPa] | 59.1 ± 11.4 | 86 ± 6.4 |
| Flexural strength [MPa] | 2.2 ± 0.3 | 2.52 ± 0.30 |
| Maximum flexural strain [%] | 8.8 ± 1.1 | 5.1 ± 0.7 |
| Maximum force [N] | 1688 ± 27 | 936 ± 107 |
| Puncture force [N] | 844 ± 29 | 467 ± 53 |
| Total energy [J] | 21.2 ± 3 | 12.2 ± 2 |
| Total deformation [mm] | 33.9 | 28.4 ± 7 |

Note:
Component made from EPC (V-4) has a foam density of 230 kg/m³. The indices here are original and would have to be calculated with a factor of 0.85 for simple percentage standardization.

TABLE 3
Complete thermal conductivity data for EPC (E1) and (V4).

| | Thermal conductivity/mW/(m · K) | | | | | |
|---|---|---|---|---|---|---|
| | Polymer | | | | | |
| | matrix | | | | | |
| | PC-1 | −10° C. | 10° C. | 25° C. | 50° C. | 70° C. |
| EPC (E-1) | 200^{#} | 44.0 | 46.2 | 47.9 | 50.7 | 52.7 |
| 200 kg/m³ | | | | | | |
| EPC (V-4) | 200^{#} | 46.2 | 48.8 | 50.7 | 53.7 | 55.6 |
| 230 kg/m³ | | | | | | |

^{#}Thermal conductivity figures for the unexpanded starting material

1: A process for producing foamed polycarbonate beads, comprising the following steps:
a) providing an aromatic polycarbonate-based composition, where the aromatic polycarbonate, based on the total weight of the aromatic polycarbonate, has a content of OH end groups of at least 350 ppm, determined by ¹H NMR spectroscopy with dichloromethane as solvent at room temperature,
b) mixing the aromatic polycarbonate-based composition with a chain extender suitable for OH groups in such a molar ratio that 0.64-1.10 mol of the reactive group of the chain extender is used per 1 mol of OH end groups of the polycarbonate,
c) providing the mixture in a plastified state,
d) mixing a physical blowing agent into the melt,
e) particle foam extrusion of the plastified mixture at a temperature T of T₁=(T_{g}+110° C.) to T₂=(T_{g}+170° C.), where T_{g} is the glass transition temperature of the aromatic polycarbonate-based composition, and
f) pelletizing the blowing agent-containing melt.

2: The process as claimed in claim 1, wherein carbon dioxide is used as the blowing agent.

3: The process as claimed in claim 1, wherein the process is performed as a continuous operation.

4: The process as claimed in claim 1, wherein the aromatic polycarbonate-based composition from step a) has a melt volume flow rate MVR of up to 12 cm³/(10 min), determined in accordance with ISO 1133:2012-3 (test temperature 300° C., mass 1.2 kg).

5: The process as claimed in claim 1, wherein the pelletization is a pelletization in liquid medium, by hot chopping or an under-air pelletization.

6: The process as claimed in claim 1, wherein the pelletization is an unpressurized underwater pelletization.

7: The process as claimed in claim 1, wherein the chain extender used is one or more epoxy-functionalized compounds.

8: The process as claimed in claim 1, wherein 0.1-2.3% by weight of physical blowing agent is added in step d, where the stated amount is based on the total weight of aromatic polycarbonate-based composition and chain extender.

9: The process as claimed in claim 1, wherein the aromatic polycarbonate in the composition from step a), based on the total weight of the aromatic polycarbonate, has a content of OH end groups of 350 to 600 ppm, determined by ¹H NMR spectroscopy with dichloromethane as solvent at room temperature.

10: The process as claimed in claim 1, wherein the aromatic polycarbonate in the composition from step a), based on the total weight of the aromatic polycarbonate, has a content of OH end groups of at least 380 ppm, determined by ¹H NMR spectroscopy with dichloromethane as solvent at room temperature.

11: The process as claimed in claim 1, wherein step b) and step d) overlap in time.

12: The process as claimed in claim 1, wherein steps a) to f) take place in the sequence stated.

13: The process as claimed in claim 1, wherein the chain extender used is an epoxy-functionalized chain extender with an epoxy equivalent weight of 285 to 485 g/mol.

14: Polycarbonate beads produced by the process as claimed in claim 1.

15: A process for producing molded articles from the polycarbonate beads as claimed in claim 14, wherein the crack gap method or the pressure filling method is utilized.
